(19) United States
(12) Patent Application Publication
(10) Pub. No.: US 2024/0378185 A1
(43) Pub. Date: Nov. 14, 2024

(54) METHOD OF DETERMINING A TABLE STRUCTURE

(71) Applicant: International Business Machines Corporation, Armonk, NY (US)

(72) Inventors: Maksym Lysak, Waedenswil (CH); Peter Willem Jan Staar, Waedenswil (CH); Nikolaos Livathinos, Adliswil (CH); Ahmed Samy Nassar, Zurich (CH); Christoph Auer, Zurich (CH)

(21) Appl. No.: 18/316,629

(22) Filed: May 12, 2023

(51) Int. Cl. G06F 16/22; G06F 16/23

(52) U.S. Cl. CPC G06F 16/2282; G06F 16/2365; G06V 30/412

(57) ABSTRACT

A computer implemented method of determining a table structure of a table. The method comprises receiving an image of the table. The method further comprises receiving the table structure of the table in response to inputting the image of the table into a table recognition neural network. The table structure comprises a single token assigned to each cell of the table. The single token assigned to each cell of the table is selected from a finite number of tokens. The table structure comprises a row of tokens for each row of the table.

### BACKGROUND

The present disclosure relates to the determination of a table structure.

The recognition of tabular layouts inside a document is useful for the automated interpretation and processing of documents. Often times the tabular layout provides a context between the different data or information or data stored within the table. The interpretation of tables in different domains may be useful, for example several applications include: interpreting financial reports, summarizing marketing flyers, interpreting production specifications, studying patents, and aggregating data from scientific documents.

### SUMMARY

In one aspect the disclosure provides for a computer-implemented method of determining a table structure of a table. The method comprises receiving an image of the table. The method further comprises receiving the table structure of the table in response to inputting the image of the table into a table recognition neural network. The table structure comprises a single token that is assigned to each cell of the table. The single token assigned to each cell of the table is selected from a finite number of tokens. The table structure comprises a row of tokens for each row of the table.

In another aspect the disclosure provides for a computer system that comprises a processor that is configured for controlling the computer system. The computer system further comprises a memory storing machine-executable instructions and a table recognition neural network. The execution of the instructions causes the processor to receive an image of the table. The execution of the instructions further causes receiving a table structure of the table in response to inputting the image of the table into the table recognition neural network. The table structure comprises a single token assigned to each cell of the table. The single token assigned to each cell of the table is selected from a finite number of tokens. The table structure comprises a row of tokens for each row of the table.

In another aspect the disclosure provides for a method of training a table recognition neural network. The method comprises receiving training data. The training data comprises pairs of training images containing a table and a ground truth training data descriptive of a table structure of the table. The table structure comprises a single token assigned to each cell of the table. The single token assigned to each cell of the table is selected from a finite number of tokens. The table structure comprises a row of tokens for each row of the table. The method further comprises training the table recognition neural network using the training data.

### BRIEF DESCRIPTION OF THE DRAWINGS

In the following embodiments of the disclosure are explained in greater detail, by way of example only, making reference to the drawings in which:

FIG. 1 illustrates an example of a computing environment.

FIG. 2 shows a further view of the computing environment.

FIG. 3 shows a flow chart which illustrates a method of using the computing environment.

FIG. 4 illustrates an exemplary image of a table.

FIG. 5 illustrates a graphical representation of the table in FIG. 4 using tokens.

FIG. 6 illustrates a method of training a table recognition neural network.

FIG. 7 illustrates a method of error correction when deploying a table recognition neural network.

FIG. 8 illustrates a method of validating a table structure.

FIG. 9 illustrates a method of determining if a table structure is rectangular.

FIG. 10 illustrates a method of checking if an L-token or cell in the table structure is used incorrectly.

FIG. 11 illustrates a method of checking if a U-token or cell in the table structure is used correctly.

FIG. 12 illustrates a method of checking if an X-token or cell in the table structure is used incorrectly.

FIG. 13 illustrates a method of detecting if there is an error in the first row of the table structure.

FIG. 14 illustrates a method of detecting if there is an error in the first column of the table structure.

FIG. 15 illustrates a method of correcting errors in the table structure.

FIG. 16 illustrates a method of making the table structure rectangular.

FIG. 17 illustrates a method of correcting errors in the first column of the table structure.

FIG. 18 illustrates a method of correcting errors in the first row of the table structure.

FIG. 19 illustrates a method of correcting an erroneous U-token or cell in the table structure.

FIG. 20 illustrates a method of correcting an erroneous L-token or cell in the table structure.

FIG. 21 illustrates a method of correcting an erroneous X-token or cell in the table structure.

FIG. 22 illustrates a method of converting the table structure to HTML.

FIG. 23 illustrates a subroutine of the method shown in FIG. 22.

FIG. 24 illustrates a further subroutine of the method shown in FIG. 22.

FIG. 25 illustrates a further subroutine of the method shown in FIG. 22.

### DETAILED DESCRIPTION

The descriptions of the various embodiments of the present disclosure will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Examples may have the advantage that the output of the table recognition neural network is more accurate. Typically, when table structures are determined for a document or table within a document, the nature of the table is marked up in a markup language such as HTML or LaTeX. A difficulty with these structures is that it is not always apparent if the table structure is valid and there may also be a large degree of nesting or complicated structures within the table structure in such a markup language. By having a single token assigned to each cell, the output may be more easily interpreted as being correct or incorrect as well as being simpler for a neural network to produce.

In some examples, the table structure of a table encompasses the organization of various cells into rows and columns of the table where various data and headers are stored.

In another example the finite number of tokens comprises at least one cell identifier token. A cell identifier token may for example be used to identify either a cell which contains data or does not contain data.

In another example the finite number of tokens comprises horizontal group member cell token. A horizontal group member cell token may be useful for identifying a horizontal region which comprises more than one cell.

In another example the finite number of tokens comprises a vertical group member cell token. This may be useful in identifying a region which is formed from more than one cell that forms a vertical structure.

In another example the finite number of tokens comprises a two-dimensional cell member token. This may be useful in identifying a member of a two-dimensional region of a table.

In another example the finite number of tokens comprises a new line token. For example, the new line token may be appended to the end of each line of tokens in a table. This for example enables the tokens in the table structure to be output as continuous strings of tokens with the new line simply being indicated by a new line token. This is simpler than is used in other markup languages such as HTML or LaTex.

In another example, the at least one cell identifier token comprises a full cell identifier and an empty cell identifier. Sometimes in documents a cell may contain data or other writing and sometimes it may not. In some examples the use of a full cell identifier can be used to indicate when data should be extracted from the table.

In another example the method further comprises identifying an error in a token of the table structure by sequentially comparing single tokens assigned to each cell to a predefined logic. This example may be beneficial because it may enable checking the output of the table recognition neural network to see if the table structure is valid. Being able to compare to the adjacent tokens sequentially enables the checking of the table structure on the fly.

In another example the method further comprises correcting the error of token using a predefined correction algorithm. This example may be beneficial because it may provide for a means of correcting the table structure and providing a suitable or correct response, even when the table recognition neural network produces an incorrect table structure.

In another example the predefined logic to identify the error comprises a check for row length consistency. For example, if the rows all have different lengths then this would indicate that there is an error in the table structure.

In another example the predefined logic to identify the error comprises a check if the table structure is rectangular. Again, this may be beneficial because it may be used as a means to indicate that the structure should be corrected.

In another example the predefined logic to identify the error comprises a check if there are no horizontal group member cell tokens in a first column of the table structure.

In another example the predefined logic to identify the error comprises a check for two-dimensional cell member tokens to determine if they have only two-dimensional cell member tokens above and to the left in the table structure.

In another example the predefined logic to identify the error comprises a check that the top-left corner of a two-dimensional cell is either a two-dimensional cell token or a cell identifier token.

In another example the predefined logic to identify the error comprises a check that a vertical group member cell only has vertical group member cell tokens or cell identifier tokens above it.

In another example the predefined logic to identify the error comprises a check that a horizontal group member cell only has horizontal group member cell tokens or cell identifier tokens to the left of it.

In another example the method further comprises correcting the error of the token by padding rows shorter than the maximum row length and that end with a cell identifier token or a horizontal group member token with horizontal group member tokens if the check for the row length consistency or the check if the table structure is rectangular has failed. Other rows shorter than the maximum row length may be padded with cell identifier tokens if the check for row length consistency or the test for rectangularity has failed.

In another example the method further comprises correcting the error of the token by replacing the token with the horizontal group member cell token if the check that there are no horizontal group member cell tokens in a first column of the table structure has failed.

In another example the method further comprises correcting the error of the token by replacing the token with the cell identifier token if the check for the two-dimensional cell member tokens fails because it does not have only two-dimensional cell member tokens above and to the.

In another example the method further comprises correcting the error of the error token by replacing the top-left corner token with the cell identifier token or the two-dimensional cell token if the check that the top-left corner of a two-dimensional cell is either a two-dimensional cell member token or a cell identifier token has failed.

In another example the method further comprises correcting the error of the token by replacing the current token with the token with the group member cell token or the cell identifier token if the check that a vertical group member cell only has vertical group member cell tokens or cell identifier tokens above it has failed.

The method further comprises correcting the error of the token by placing the token with the horizontal group member token or the cell identifier token if the check that the horizontal group member cells only has horizontal group member cell tokens or cell identifier tokens to the left of it has failed.

In another example the method further comprises converting the table structure into HTML, XML, LaTex, or markdown (MD) by iteratively converting rows identified by the new line token into tags and/or elements.

In another example the method further comprises correlating the table structure with locations in the image of the table. The method further comprises extracting data corresponding to the location of the cell identifier locations from the image of the table and the method further comprises inserting the table data into the table structure. This may be particularly advantageous because it may provide for a means of adding arbitrary data into the table structure. For example, it would then be independent of language and such things as mathematical equations or other symbolic structures could also be inserted in addition to normal OCR text.

In another example, the data extraction is performed using optical character recognition.

In another example the data extraction is performed extracting the data from a source document of the image of the table. For example, it could be extracted from the source document of a PDF file.

In another example the table recognition neural network is implemented using a ResNet neural network that feeds a feature vector to a transformer encoder neural network with multiple encoder layers. The table recognition neural network is further implemented such that the output of the transformer encoder neural network is passed to a structure decoder neural network. The structure decoder neural network is implemented as a transformer encoder with multiple decoder layers. The ResNet is configured for receiving the image of the table. The structure decoder neural network is configured for outputting the table structure.

In another example the table recognition neural network is implemented using an image encoder decoder or an image encoder dual decoder network. If an image encoder decoder neural network is used, then for example simply the structure of the table is output. If an image encoder dual decoder network is used this could be used to identify both the location of a token within the image as well as the token.

In another example the table recognition neural network is implemented using image encoder text decoder neural network architecture.

In another example the single token assigned to each cell of the table is associated with a token-specific area of the image of the table or a bounding box identifying the token-specific area of the image of the table. This may for example be useful in extracting text, symbolic data or other data or information from the table and associating it with a particular token.

In another example the method further comprises receiving the training data with the ground truth data in a markup language or a structure representation. The method further comprises converting the ground truth data from the markup language a structure representation to the table structure with a single token assigned to each cell of the table before training.

In another example the markup language or the structure representation is any one of the following: HTML, XML, LaTex, or MD.

In another example the method further comprises identifying an error in a token of the table structure by sequentially comparing the single token assigned to each cell to a predefined logic. The various types of predefined logic have been described above.

In another example the method further comprises correcting the error of the token using a predefined correction algorithm. The predefined correction algorithm has been previously described above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as an implementation of a table recognition neural network 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

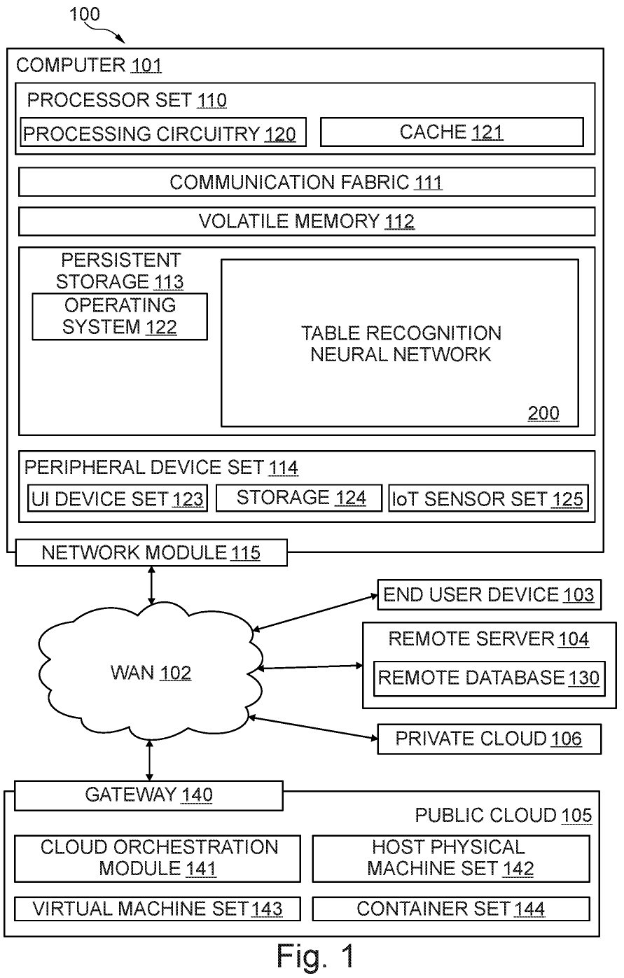

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

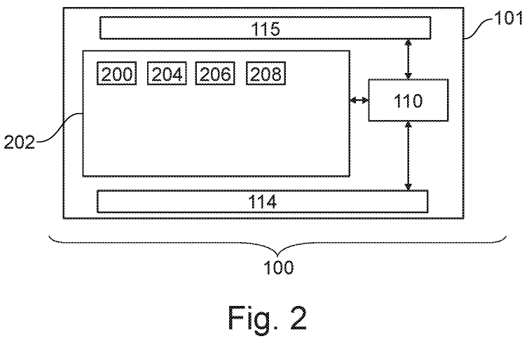

FIG. 2 illustrates a further example of the computing environment 100. This is shown as comprising the computer 101. The processor set 110 is in communication with the network module 115 and the peripheral device set 114. Box 202 represents a memory that could be a combination of the volatile memory 112 and/or the persistent storage 113. The memory 202 is shown as comprising machine-executable instructions 204. The machine-executable instructions 204 enable the processor set 110 to perform various data analysis functions. The memory 202 is further shown as containing the table recognition neural network 200. The memory 202 is further shown as containing an image 206 of a table. The memory 202 is further shown as containing a table structure 208 which represents the table depicted in the image 206; it was obtained in response to inputting the image 206 into the table recognition neural network 200.

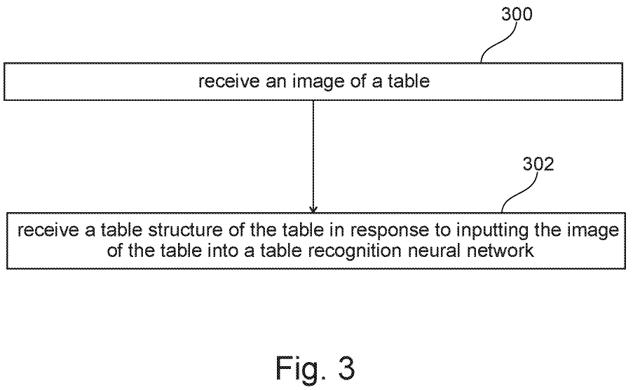

FIG. 3 shows a flowchart which illustrates a method of operating the computing environment 100. First, in step 300, the image 206 of the table is received. Next, in step 302, the table structure 208 is received in response to inputting the image 206 into the table recognition neural network 200.

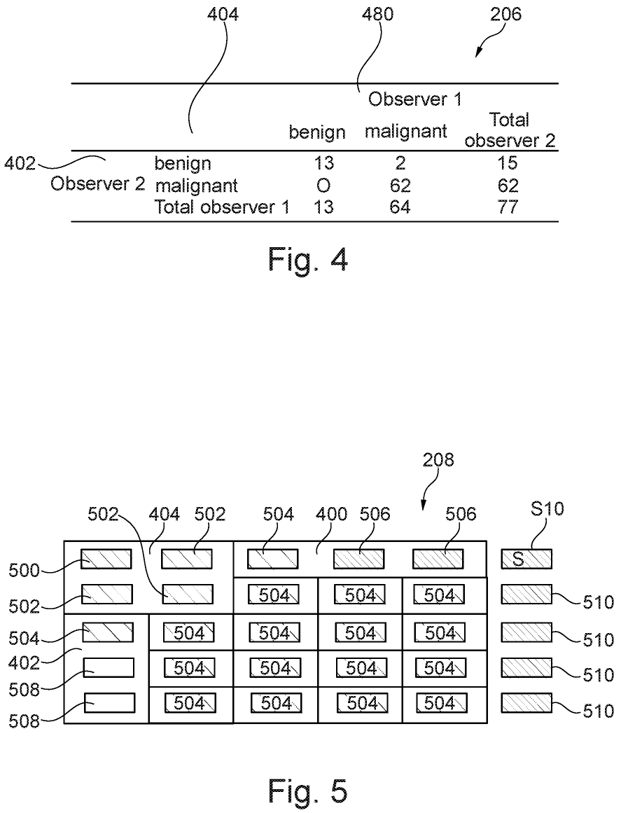

FIG. 4 illustrates an example of an image 206 of a table. It can be seen that there is various data and headers in this table. The table structure, depicted in FIG. 4, has some complicated structures in it. It can be seen that there is a region with a horizontal span 400. There is another region with a vertical span 402 and an additional region with empty cells that form a two-dimensional span 404.

FIG. 5 is a representation of the table structure 208 in graphical form. It can be seen that the region is divided into different portions. There is a portion that represents the horizontal span 400, the vertical span 402, and the empty cells which form a two-dimensional span 404. Within the empty cells with the two-dimensional span 404 there is an empty cell token 500 in the upper-left corner surrounded by two-dimensional span cells that indicate a connection 502 in the left-up direction. The token 502 indicates that the cell is a member of a two-dimensional span connected with cells in the left and upward direction.

The horizontal span 400 starts with a full cell 504 and then has two left-looking cells 506 to the left of it. The left-looking cells 506 indicate they form part of a span which is connected to a cell to the left of it.

The vertical span 402 has a full cell 504 at the top with two up-looking cells 508 below it. The up-looking cells represent a token which form a vertical span. At the end of each row of the table there is a new line cell 510 which represents a token indicating a new line. The remaining cells of the table are filled with full cell tokens 504.

If the empty cell 500 is represented by an E-token, the two-dimensional span cells in the left-up direction 502 are represented by an X-token, the full cell is represented by an F-token, the left-looking cell 506 is represented by an L-token, the up-looking cell 508 is represented by a U-token, and the new line cell 510 is represented by an nl-token, then the table structure 208 shown in FIG. 5 can be written as:

E X F L L nl
X X F F F nl
F F F F F nl
U F F F F nl
U F F F F nl

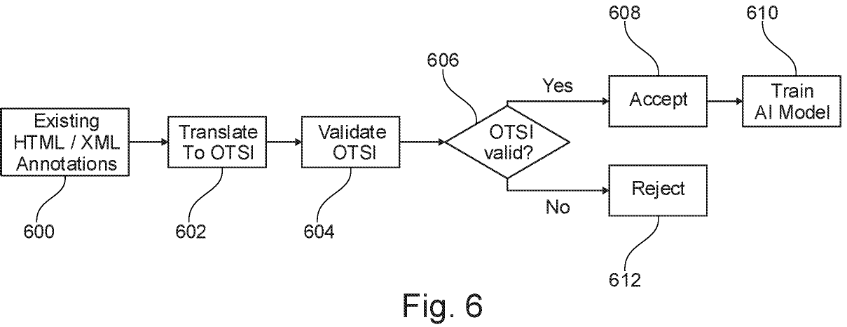

FIG. 6 illustrates a method of training the table recognition neural network. First, in step 600, existing training data with XML and HTML annotations are received. Next in step 602, they are translated to OTSI. The OTSI may be used herein as an abbreviation for the output table structure of the table recognition neural network that comprises a single token assigned to each cell of the table with the single token assigned to each cell of the table selected from a finite number of tokens. After step 602 the method proceeds to step 604 where the table structure is validated. Step 606 is a decision box, if the OTSI is valid the method proceeds to step 608 where the training data is accepted and then is used to train the AI model in 610. If the table structure is determined as not being valid the method proceeds to step 612 and the particular table with the training data is rejected in step 612.

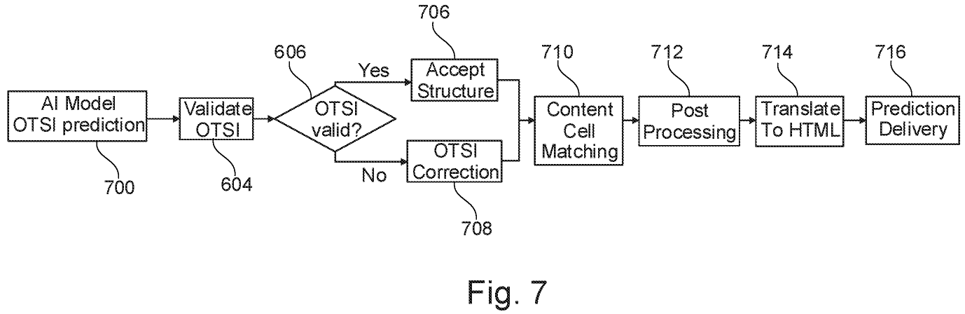

FIG. 7 illustrates a method of error correction in the prediction of the table structure using the table recognition neural network. The method starts in block 700 where the table recognition neural network provides the OTSI prediction. Next, the method proceeds to block 604 which provides a validation step or checking of the table structure. Block 606 is a decision block, where if the structure is correct the method proceeds to step 706. If the structure is not correct the method proceeds to block 708 where the OTSI or table structure is corrected. After block 706 or 708 is performed the method proceeds to block 710, where there is content cell matching. This for example would match the location within a table to the particular token so the data can be associated with the token. Next, in step 712, any post-processing is performed. Previously post-processing may have required a bounding box or box correction; in this new implementation only a bounding box correction needs to be provided. After block 712 the method proceeds to block 714, where the table structure is converted into HTML. In block 716 the HTML, along with any associated data from within the cells, is provided as the prediction delivery or the data provided by the method.

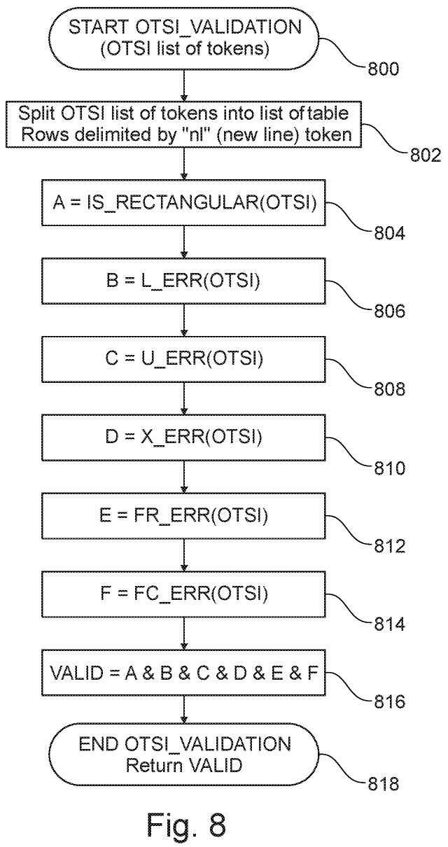

FIG. 8 illustrates how a method of validating a table structure as depicted in block 604 of FIGS. 6 and 7 may be performed. The method starts with block 800. Next, in block 802, the OTSI list of tokens is split into lists of table rows determined by the new line token. After block 804 the rectangularity of the table is checked. After this, in step 806, the table is checked for errors in the L-tokens. Next, in block 808, the errors are checked for in the U-token blocks. After this, in step 810, errors in the X-tokens are checked. Then, in step 812, the errors in the first row of the table are checked. After this, in block 814, errors in the first column are checked. Step 816 is a check if any of the above checks have indicated an error. In block 818 the results of the validation are returned.

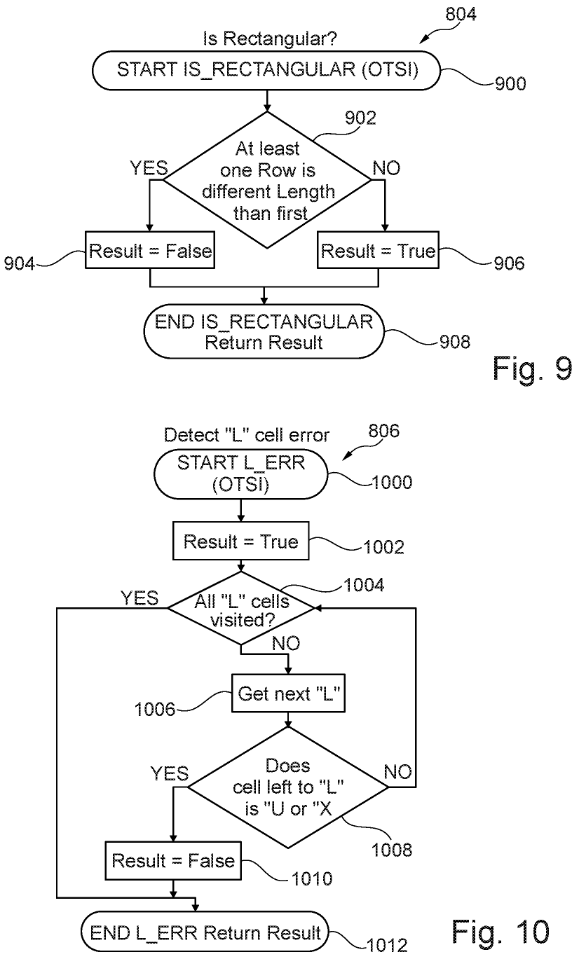

FIG. 9 illustrates the test 804 to determine if the blocks are rectangular. The block starts with block 900. Block 902 is a decision block where the question is, is at least one row different in length than the first? If the answer is “yes,” 904, then this indicates an error and the result is equal to false. The method then ends in step 908. If the answer in block 902 is “no,” the method proceeds to block 906 and the result is set to true, which indicates that the block is indeed rectangular. Then the method ends again in block 908.

FIG. 10 illustrates the check in block 806. This is to detect a so-called L-token error. In the L-token cell rule or error, only an L-token, F-token, or E-token is allowed to be to the left of an L-token. The method starts in block 1000. In step 1002 the method is additionally set to true. Block 1004 is a decision block, which asks have all L-token cells been visited? If the answer is “yes” the method proceeds to block 1012 and the method ends. If the answer is “no” the block proceeds to block 1006 and one obtains the next L-token. In block 1008 there is a decision block, is the cell to the left of the L-, A-, U-or X-token. If the answer is “yes” the method returns to block 1010, where the result is set to false and the method errors at block 1012 again. If the answer to the question in block 1008 is “no,” the method returns back to cell 1004.

FIG. 11 indicates one method of performing block 808 in FIG. 8. It is to detect a so-called U-cell or U-token error. In the U-cell or token rule only a U-cell or an F-token or E-token is allowed on top of a U-token. The method starts in block 1100. It then proceeds to block 1102 where the result is set to true. In block 1104 there is a question block, which asks, have all U-cells or tokens been visited? If the answer is “yes,” the method proceeds to block 1112 and ends. If the answer is “no” the method proceeds to block 1106 where the next U-token cell is obtained. It then proceeds to decision block 1108. In block 1108 the question is, is the cell above the U-token an L-token or an X-token? If the answer is “yes” the block proceeds to step 1110 and the result is set to false and the method then ends in block 1112. If the answer is no to block 1108 the method proceeds back to block 1104.

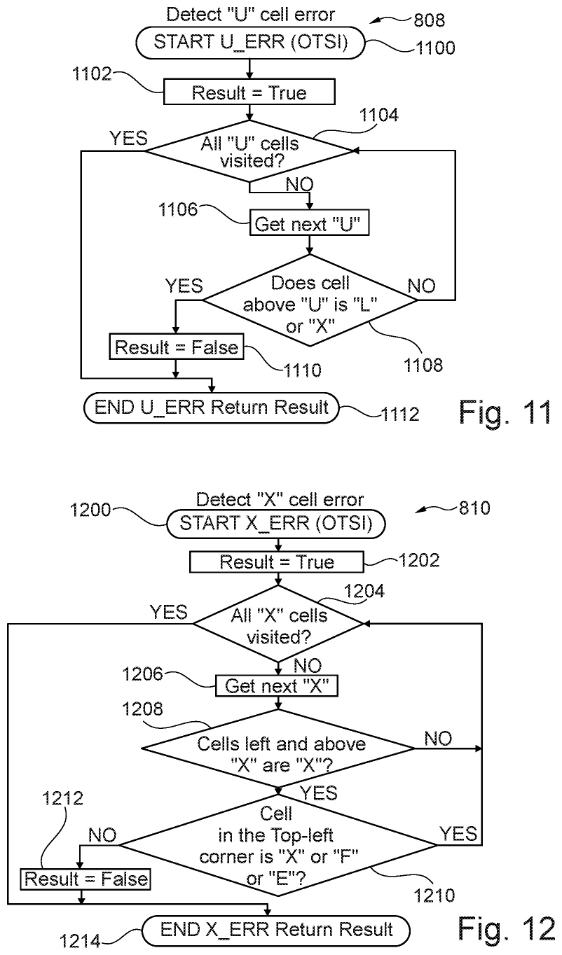

FIG. 12 shows a flowchart which illustrates a method of performing step 810 in FIG. 8. In FIG. 12 the error of the x-cell or token may be detected. In this rule, when both the left and top cells from a given X-token are also X-tokens or cells, then the top-left corner of this cell must be either an X-, F- or E-token or cell.

In FIG. 12 the method starts with block 1200. Next in block 1202 the result is set equal to true. Block 1204 after this is a decision block. The question is, have all x-cells or tokens been visited? If the answer is “yes” the method proceeds to block 1214 and the method ends. If the answer is “no,” then the method proceeds to block 1206, which is to get the next L-cell or token. In block 1208 there is another question block, are the cells left and above the current X-cell is also an X-cell or token? If the answer is “no” the method proceeds back to block 1204. If the answer is “yes,” it goes to decision block 1210. In decision block 1210 the question is, are cells in the top-left corner an X-token, F-token, or E-token? If the answer is “yes” the method proceeds back to block 1204. If the answer is “no” in block 1210, the method proceeds to block 1212, where the result is set as being equal to false. The method then ends in block 1214.

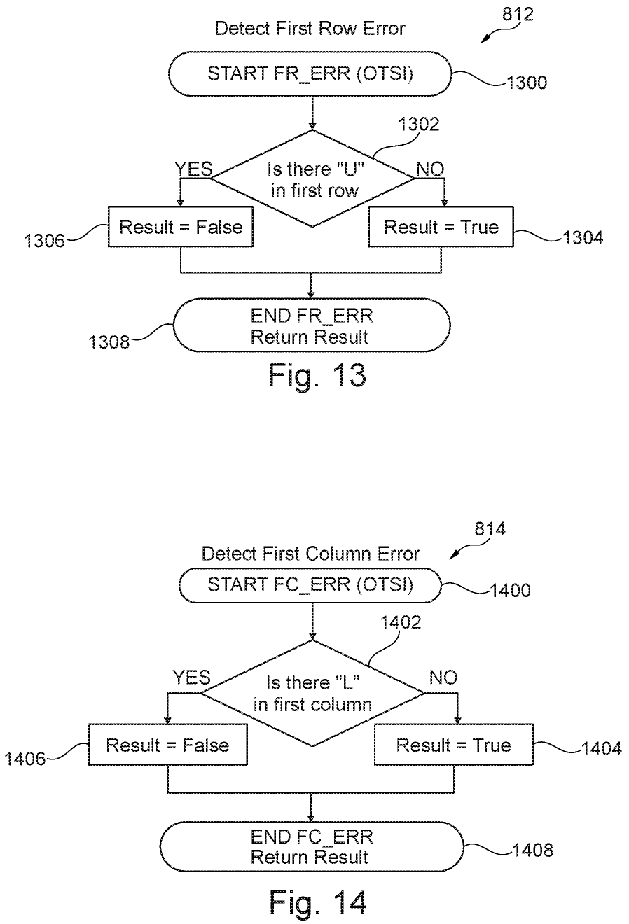

FIG. 13 illustrates one method of performing block 812 in FIG. 8. In FIG. 13 an error in the first row of the table structure may be detected. The method starts in block 1300. It then proceeds to question block 1302. The question is, is there a U-token in the first row? If the answer is “no” the result is set to true in block 1304 and then the method ends in block 1308. If the answer to block 1302 is “yes,” the method proceeds to block 1306, where the result is set equal to false. The method then ends in block 1308.

FIG. 14 illustrates a method of detecting an error in the first column. The method starts in block 1400. It then proceeds to block 1402 where there is a question block that asks, is there an L-token in the first column. If the answer is no, the method proceeds to block 1404 and the result is set equal to true. The method then ends in block 1406. If the answer to the question in block 1402 is yes, the method proceeds to block 1406 where the result is set equal to false. The method then ends in block 1408.

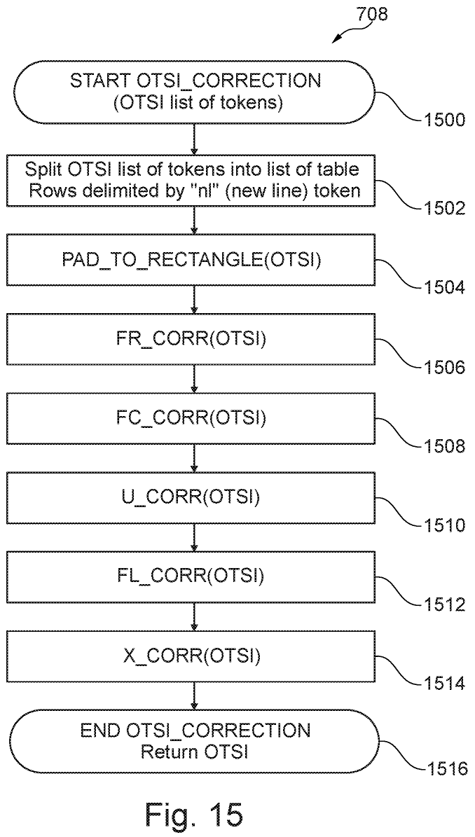

FIG. 15 illustrates one method of how to perform block 708 in FIG. 7. The method in FIG. 15 starts in block 1500. Next, in block 1502, the OTSI list of tokens is split into a list of table rows delineated by the new line token. Next, in block 1504 rows in the table may be padded with additional tokens to make the table structure rectangular. Next, in block 1506, a first column correction may be performed. Next, in block 1508, a first row correction may be performed. Next, in block 1510, a U-token correction may be performed. Next, in block, 1512 a L-token correction may be performed. Next, in block 1514, an X-token correction may be performed. Finally, the method ends in block 1516.

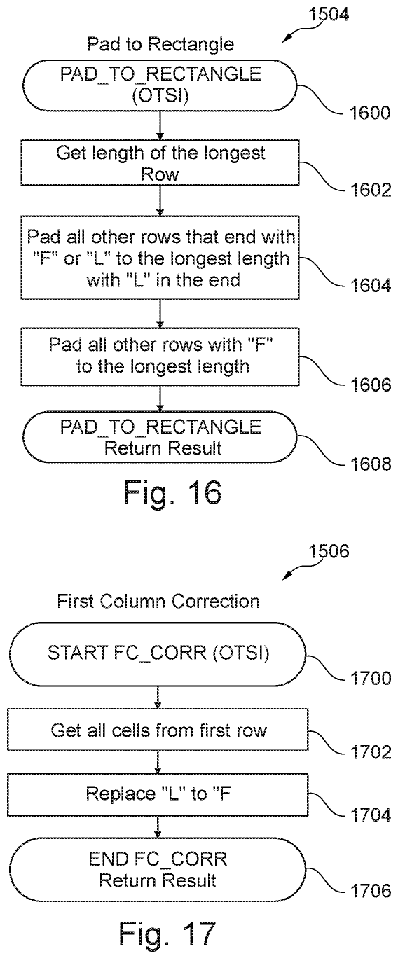

FIG. 16 illustrates one method of how to perform block 1504 in FIG. 15. In FIG. 16 the table structure may be padded so as to cause the table structure to have a rectangular shape. The method begins in block 1600. Next, in block 1602, the length of the longest row of the table structure is obtained. Next, in block 1604, all of the rows, except those with the longest length, are padded such that the end with an F-token or L-token up to the longest length with an L-token in the end. Next, in block 1606, all other rows are padded with an F-token to the longest length. The method then ends in block 1604.

FIG. 17 illustrates a method of how to perform block 1506 in FIG. 15. In FIG. 17 a correction of the first column is performed. The method starts in block 1700. Next, in block 1702, is to get all cells from the first row. Next, in block 1704, all tokens are replaced with an F-token. The method then ends in block 1706.

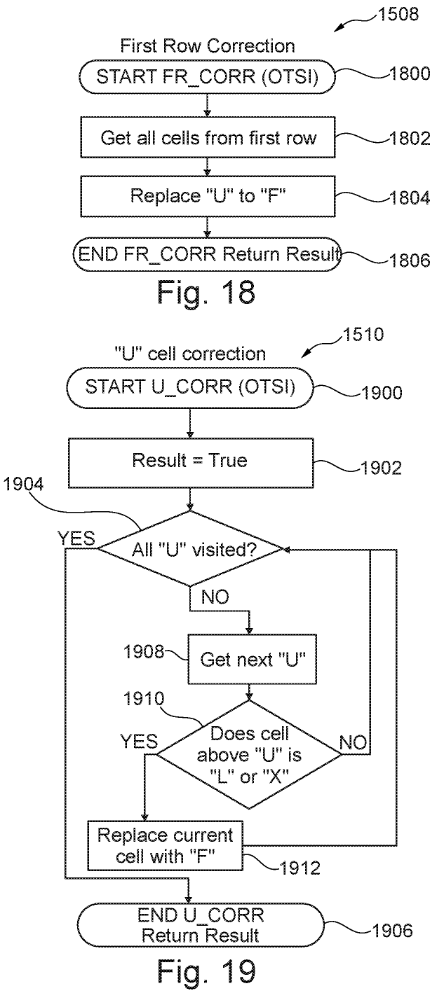

FIG. 18 illustrates a method of performing block 1508 in FIG. 15. In FIG. 18 a correction of the first row is performed. The method starts in block 1800. Next, in block 1802 it is instructed to get all cells from the first row. In block 1804, all U-tokens are replaced with an F-token. The method then ends in block 1806.

FIG. 19 shows a correction of a u-cell or token and represents one method of performing block 1510 in FIG. 15. The method starts in block 1900. Next, in block 1902, the result is set equal to true. Block 1904 is a decision block, in this block 1904 the question is, have all U-tokens or cells been visited? If the answer is “yes” the method then ends at block 1906. If the answer is “no” the method proceeds to block 1908 and the next U-cell or token is obtained. It then proceeds to decision block 1910. The question in block 1910 is, is the cell above the U-token or cell is an L-or X-token or cell? If the answer is “no” the method proceeds back to block 1908. If the answer is “yes” the method then proceeds to block 1912 where the current token is replaced with an F-token. The method then goes back to block 1904.

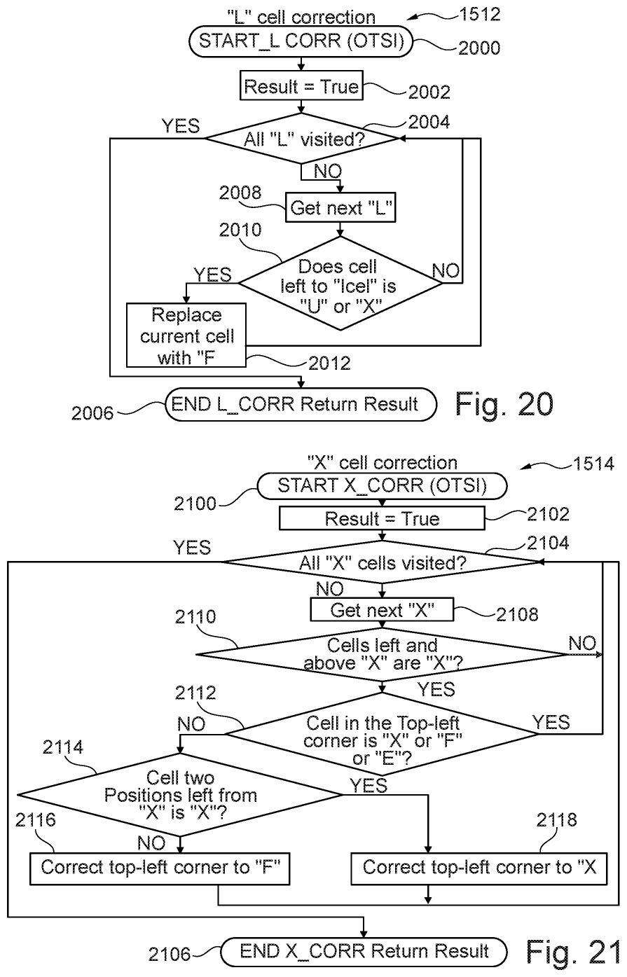

FIG. 20 shows a method of correcting an I-cell or token. It represents one method of performing the steps in block 1512 in FIG. 15. The method starts in block 2000. Next, in block 2002, the result is set equal to true. The method then proceeds to decision block 2004. The question in this decision block is, have all L-tokens or cells been visited? If the answer is “yes” the method proceeds to block 2006 and the method ends. If the answer is “no,” the method proceeds to block 2008. In block 2008 the next L-cell or token is obtained. It then proceeds to decision block 2010. The question in block 2010 is, is the cell left to current L-cell or token is a U-or an X-cell or token. If the answer is “no” the method proceeds back to block 2004. If the answer is “yes” the method proceeds to block 2012 and the current cell or token is replaced with an F-token. The method then proceeds back to block 2004.

FIG. 21 illustrates a method of performing an X-cell or token correction. It illustrates a method of performing the steps in block 1514 in FIG. 15. The method starts with block 2100. In block 2102 the result is set equal to true. Next is decision block 2104. In block 2104 the question is, have all X-cells or tokens been visited? If the answer is “yes,” the method goes to block 2106 and the method ends. If the answer is “no,” the method then proceeds to block 2108. In block 2108 the next L-token or cell is obtained. It then proceeds to a decision block 2110. The question in block 2110 is, are the cells left and above of the current X-cell or token is also an X-cell or token. If the answer is “no,” the method then proceeds back to block 2104. If the answer is “yes,” the method then proceeds to decision blocks 2112. The question in decision block 2112 is, are cells in the top-left corner an X-token, an F-token or an E-token? If the answer is “yes” the method proceeds back to block 2104. If the answer is no, the method proceeds to decision block 2114. In block 2114 the question is, is the cell two positions left from the current X-cell or token also an X-cell or token? If the answer is “yes,” the method proceeds to block 2116 and the top-left corner of the block is converted to an F-token. Then the method proceeds back to block 2104. If the answer to the question in block 2114 is “yes,” then the method proceeds to step 2118. In block 2118 the token in the top-left corner is corrected to being an X-token. After this, the method then proceeds to block 2104.

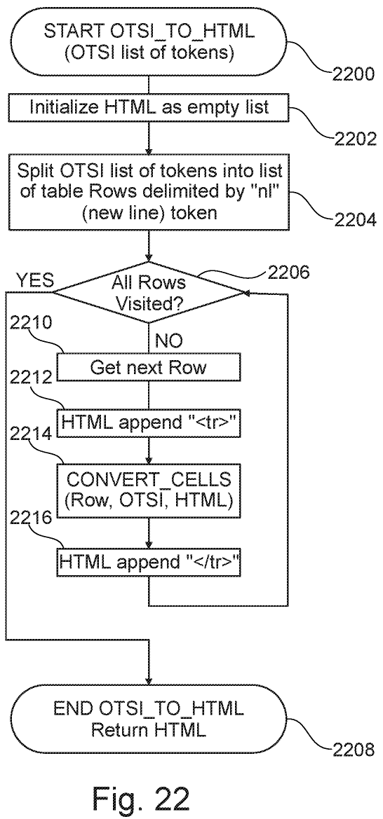

FIG. 22 illustrates a method of converting the OTSI tokens to an HTML format. The method starts in block 2200. Next in block 2202 the HTML output is initialized as an empty list. Next, in block 2204, the OTSI list of tokens is split into a list of table rows delineated by the new line token. Next, in block 2206, a question is asked, have all rows been visited? If the answer is “yes,” the method proceeds to block 2208 and the method ends with the HTML being returned. If the answer is “no,” the method proceeds to block 2210. In this step the next row of tokens is obtained. Next, in block 2212, a <tr> marker is appended. Next, in block 2214, a convert cells sub-routine is performed. After block 2214 block 2216 is performed. In block 2216 an </tr> marker is added to the HTML. After block 2216 is performed the method returns to block 2206.

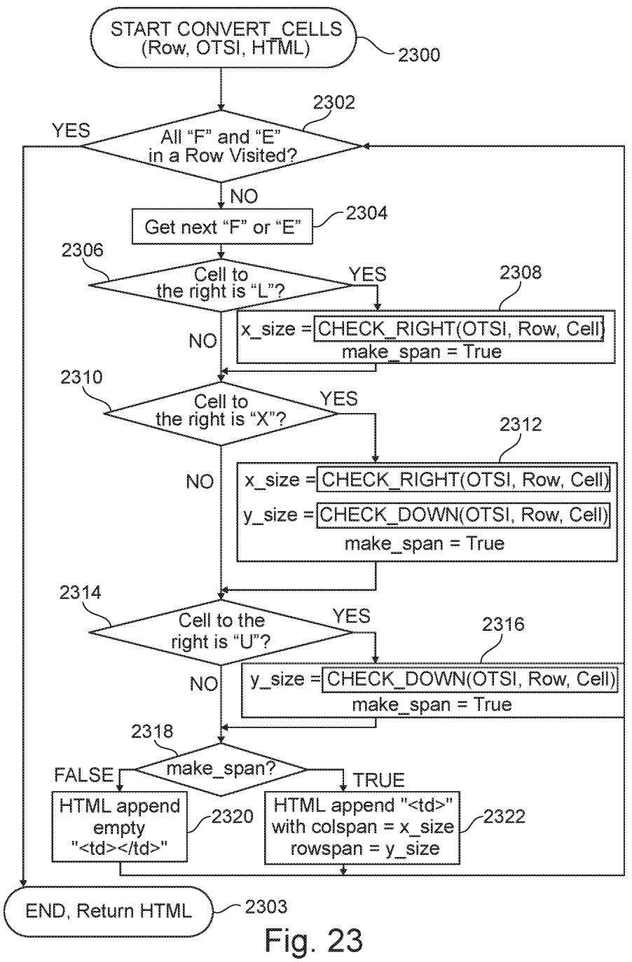

FIG. 23 illustrates how the convert cells sub-routine may be implemented. The method starts in block 2300. The method then proceeds to block 2302, which is a decision block. The question is, are have all “F” and “E” cells or tokens in a row been visited? If the answer is “yes” the method proceeds to block 2303. Then the method ends. If the answer is “no,” then the method proceeds to block 2304. In block 2304 the next “F” or “E” cell or token is obtained. Next, in block 2306, is the cell to the right of the current cell is “L” cell or token?. If the answer is “yes,” the method proceeds to block 2108. In block 2108, the check rate sub-routine is performed as is illustrated in the Figure. The method then proceeds to block 2310. If the answer to block 2306 is “no,” the method also proceeds to block 2310. Block 2310 is a decision block. In block 2310 the question is, is the cell to the right of the current cell ax “X” cell or token?. If the answer is “yes” the method proceeds to block 2310 and the check right and check down sub-routines are performed, as is illustrated in the Figure.

After block 2312 is performed, the method then proceeds to block 2314. If the answer to the question in block 2310 is no, the method also proceeds to block 2314. Block 2314 is another question block. The question is, is the cell below the current cell a “U” cell or token. If the answer is “yes” the method then proceeds to block 2316. In block 2316 the check-down sub-routine is performed as is illustrated in the Figure. After block 2316 is performed, block 2318 is performed. If the answer to the question in block 2314 is no, block 2318 is also performed. Block 2318 is another question block. In this question block the question is make span. If the answer is false then the block proceeds to block 2320 and the HTML is appended with the empty <td> and </td> markers. The method then proceeds back to block 2302. If the answer to the question in block 2318 is “yes,” the method proceeds to block 2322. In block 2322 the HTML is appended with the <td> tag with the column span that is equal to x_size and the row span is equal to y_size. After block 2322 is performed, the method then proceeds back to block 2302.

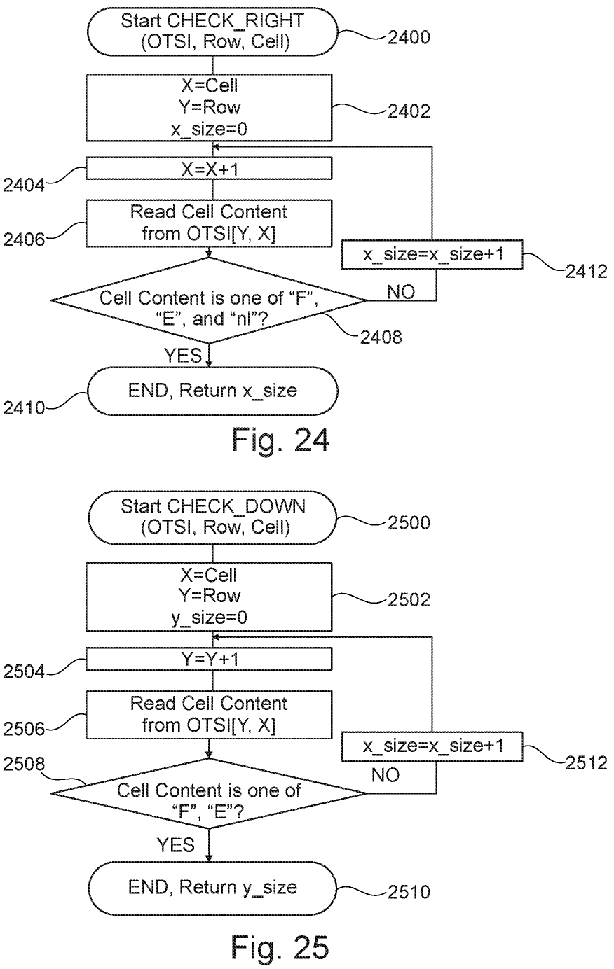

FIG. 24 illustrates a method of performing the check-right sub-routine. The sub-routine starts in block 2400. In block 2402 x is equal to the cell and y is set equal to the row and x,y is set equal to 0. In block 2404 the x is incremented by a value of 1. Next, in block 2406, the read cell content from the OTSI x,y step is performed. After block 2406 the method proceeds to question block 2408. The question is, is the cell content or type one of an “F,” “E,” and “nl” block or token?. If the answer is “yes” then the sub-routine ends in step 2410 returning the x_size value. If the answer to the question in block 2408 is “no,” then the method proceeds to block 2412 and x-size is equal to x-size +1 is incremented by 1. After block 2412 is performed, the method proceeds back to block 2404.

Block 25 shows a method of implementing the check-down sub-routine. The sub-routine begins in block 2500. In block 2502 x is equal to cell, y is initialized as row and y_size is initialized as 0. Next, in block 2505, y is incremented by 1. Next in block 2506 the step, read cell content from 0TSI x,y is performed. After block 2506, the method proceeds to decision block 2508. The question is, is the cell content one of an “F” or “E” cell or token? If the answer is “yes,” the method proceeds to block 2510 and the value y_size is returned. If the answer to the question in block 2508 is “no,” the method proceeds to block 2512, where y_size is incremented by 1. After block 2512, the method returns to block 2504.

What is claimed is:

1. A computer implemented method of determining a table structure of a table, wherein the method comprises:
receiving an image of the table; and
receiving the table structure of the table in response to inputting the image of the table into a table recognition neural network, wherein the table structure comprises a single token assigned to each cell of the table, wherein the single token assigned to each cell of the table is selected from a finite number of tokens, wherein the table structure comprises a row of tokens for each row of the table.

2. The computer implemented method of claim 1, wherein the finite number of tokens comprises:
at least one cell identifier token,
a horizontal group member cell token,
a vertical group member cell token,
a two-dimensional cell member token, and
a new line token.

3. The computer implemented method of claim 2, wherein the at least one cell identifier token comprises a full cell identifier and an empty cell identifier.

4. The computer implemented method of claim 2, wherein the method further comprises identifying an error in a token of the table structure by sequentially comparing single token assigned to each cell to a predefined logic.

5. The computer implemented method of claim 4, wherein the method further comprises correcting the error of the token using a predefined correction algorithm.

6. The computer implemented method of claim 4, wherein the predefined logic to identify the error comprises any one of the following:
a check for row length consistency;
a check if the table structure is rectangular;
a check that there are no horizontal group member cell tokens in a first column of the table structure;
a check for two-dimensional cell member tokens to determine if they have only two-dimensional cell member tokens above and to the left in the table structure;
a check that the top-left corner of a two-dimensional cell is either a two-dimensional cell token or a cell identifier token;
a check that a vertical group member cell only has vertical group member cell tokens or cell identifier tokens above it;
a check that a horizontal group member cell only has horizontal group member cells tokens or cell identifier tokens to the left of it; and
combinations thereof.

7. The computer implemented method of claim 6, wherein the method further comprises correcting the error of the token by performing any one of the following:
padding rows shorter that a maximum row length and that end with a cell identifier token or a horizontal group member token with horizontal group member tokens if the check for row length consistency or the check if the table structure is rectangular failed, wherein other rows shorter than the maximum row length are padded with cell identifier tokens if the check for row length consistency or the check if the table structure is rectangular failed;
if the check that there are no horizontal group member cell tokens in a first column of the table structure is failed then replace the token with the horizontal group member cell token;
if the check for two-dimensional cell member tokens to determine if they have only two-dimensional cell member tokens above and to the left in the table structure fails then replace the token with the cell identifier token;
if the check that the top-left corner of a two-dimensional cell is either a two-dimensional cell member token or a cell identifier token fails then replace the top-left corner with the cell identifier token or the two-dimensional cell token;
if the check that a vertical group member cell only has vertical group member cell tokens or cell identifier tokens above it fails then replace the token with the token with the group member cell token or the cell identifier token;
if the check that a horizontal group member cells only has horizontal group member cells tokens or cell identifier tokens to the left of it fails then replace the token with the horizontal group member token or the cell identifier token; and
combinations thereof.

8. The computer implemented method of claim 1, wherein the method further comprises converting the table structure into HTML, XML, LaTeX, or MD by iteratively converting rows identified by the new line token into tags and/or elements.

9. The computer implemented method of claim 1, wherein the method further comprises:
correlating the table structure with locations in the image of the table;
extracting data corresponding to the location of cell identifier locations from the image of the table; and
inserting the data into the table structure.

10. The computer implemented method of claim 9, wherein the data extraction is performed using any one of the following: optical character recognition and extracting the data from a source document of the image of the table.

11. The computer implemented method of claim 1, wherein the table recognition neural network is implemented using a ResNet neural network that feeds a feature vector to a transformer encoder neural network with multiple encoder layers, wherein the table recognition neural network is further implemented such that the output of the transformer encoder neural network is passed to a structure decoder neural network, wherein the structure decoder neural network is implemented as a transformer encoder with multiple decoder layers, wherein the ResNet neural network is configured for receiving the image of the table, wherein the structure decoder neural network is configured for outputting the table structure.

12. The computer implemented method of claim 1, wherein the table recognition neural network is implemented using an image encoder decoder network or an image encoder dual decoder network.

13. The computer implemented method of claim 1, wherein the table recognition neural network is implemented using an image encoder text decoder neural network architecture.

14. The computer implemented method of claim 1, wherein the single token assigned to each cell of the table is associated with a token specific area of the image of the table or a bounding box identifying the token specific area of the image of the table.

15. A computer system comprising:
a processor configured for controlling said computer system; and
a memory storing machine executable instructions and a table recognition neural network, execution of said instructions causes said processor to:
receive an image of a table;
receiving a table structure of the table in response to inputting the image of the table into the table recognition neural network, wherein the table structure comprises a single token assigned to each cell of the table, wherein the single token assigned to each cell of the table is selected from a finite number of tokens, wherein the table structure comprises a row of tokens for each row of the table.

16. A method of training a table recognition neural network, wherein the method comprises:
receiving training data, wherein the training data comprise pairs of training images containing a table and ground truth data descriptive of a table structure of the table, wherein the table structure comprises a single token assigned to each cell of the table, wherein the single token assigned to each cell of the table is selected from a finite number of tokens, wherein the table structure comprises a row of tokens for each row of the table; and
training the table recognition neural network using the training data.

17. The method of claim 15, wherein the method further comprises:
receiving the training data with the ground truth data in a markup language or structure representation; and
converting the ground truth data from the markup language or structure representation to the table structure with the single token assigned to each cell of the table before training.

18. The method of claim 16, wherein the markup language or structure representation is any one of the following: into HTML, XML, LaTeX, or markdown.

19. The method of claim 16, wherein the method further comprises identifying an error in a token of the table structure by sequentially comparing single token assigned to each cell to a predefined logic, wherein the predefined logic to identify the error comprises any one of the following:
a check for row length consistency;
a check if the table structure is rectangular;
a check that there are no horizontal group member cell tokens in a first column of the table structure;
a check for two-dimensional cell member tokens to determine if they have only two-dimensional cell member tokens above and to the left in the table structure;
a check that the top-left corner of a two-dimensional cell is either a two-dimensional cell token or a cell identifier token;
a check that a vertical group member cell only has vertical group member cell tokens or cell identifier tokens above it;
a check that a horizontal group member cells only has horizontal group member cells tokens or cell identifier tokens to the left of it; and
combinations thereof.

20. The method of claim 19, wherein the method further comprises correcting the error of the token using a predefined correction algorithm, wherein the method further comprises correcting the error of the token by performing any one of the following:
padding rows shorter that a maximum row length and that end with a cell identifier token or a horizontal group member token with horizontal group member tokens if the check for row length consistency or the check if the table structure is rectangular failed, wherein other rows shorter than the maximum row length are padded with cell identifier tokens if the check for row length consistency or the check if the table structure is rectangular failed;
if the check that there are no horizontal group member cell tokens in a first column of the table structure is failed then replace the token with the horizontal group member cell token;
if the check that check for two-dimensional cell member tokens to determine if they have only two-dimensional cell member tokens above and to the left in the table structure fails then replace the token with the cell identifier token;
if the check that check that the top-left corner of a two-dimensional cell is either a two-dimensional cell member token or a cell identifier token fails then replace the top-left corner with the cell identifier token or the two-dimensional cell token;
if the check that check that a vertical group member cell only has vertical group member cell tokens or cell identifier tokens above it fails then replace the token with the token with the group member cell toke or the cell identifier token;
if the check that check that a horizontal group member cells only has horizontal group member cells tokens or cell identifier tokens to the left of it fails then replace the token with the horizontal group member token or the cell identifier token; and
combinations thereof.
